(19) United States
(12) Patent Application Publication
(10) Pub. No.: US 2012/0132422 A1
(43) Pub. Date: May 31, 2012

(54) INTERPOLYMER CROSSLINKED GEL AND METHOD OF USING

(76) Inventors: Andrey Mirakyan, Katy, TX (US); Philip F. Sullivan, Bellaire, TX (US); Rick D. Hutchins, Sugar Land, TX (US); Lijun Lin, Sugar Land, TX (US); Gary John Tustin, Cambridge (GB); Bruno Drochon, Cambridge (GB)

(21) Appl. No.: 13/306,561

(22) Filed: Nov. 29, 2011

Related U.S. Application Data
(60) Provisional application No. 61/418,211, filed on Nov. 30, 2010.

(51) Int. Cl. E21B 43/00; C09K 8/588

(52) U.S. Cl. 166/279; 507/225

(57) ABSTRACT

Disclosed herein is a gel comprising, polyacrylamide crosslinked with a non-metallic crosslinker, the non-metallic crosslinker comprising a polyamine. A method of making the gel and a method of using the gel are also disclosed.

### CROSS REFERENCE TO RELATED APPLICATIONS

This application claims priority to and the benefit of provisional application U.S. 61/418,211, filed Nov. 30, 2010, which is hereby incorporated herein by reference in its entirety.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A CD

Not applicable.

### BACKGROUND

The statements in this section merely provide background information related to the present disclosure and may not constitute prior art.

Various methods have been used in the past to achieve gelling including systems triggered by pH adjustment, temperature and the like. Attempts at using gels to address fluid loss in highly porous underground formations include injecting an acidic solution following a polymer solution to produce gelation. However, gelation typically occurs so rapidly that a sufficient indepth plugging is not effectively obtained in the most permeable strata where desired. Other attempts include injecting water, a polymer and a crosslinking agent capable of gelling the polymer. Crosslinking agents are typically sequestered polyvalent metal cations, which are admixed, and, just before injection into an underground formation, an acid is added thereto to effect gelation. However, when the acid is pre-mixed with the gelable composition, the gelation can be too fast, making it necessary to shear the gelled polymer in order to be able to obtain adequate injection, which reduces effectiveness of the gel.

Indepth gelling has also been effected by the controlled gelation of sodium silicate. Also, polymers have previously been gelled in permeable zones by borate ions supplied in various ways. However, forming a gel having adequate control over gelation, gel strength, and gel composition down hole remains an illusive goal.

### SUMMARY

The instant disclosure is directed to a partially hydrolyzed polyacrylamide gel crosslinked with a non-metallic crosslinker comprising a polyamine. This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE SEVERAL VIEWS OF THE DRAWINGS

FIG. 1 is a graphical representation showing the effect of pH on viscosity of gels according to embodiments of the instant disclosure;

FIG. 2 is a graphical representation showing the effect of pH on viscosity of gels at 133° C. according to embodiments of the instant disclosure;

FIG. 3 is a graphical representation showing the effect of pH on viscosity of gels at 148° C. according to embodiments of the instant disclosure;

FIG. 4 is a graphical representation showing the effect of pH on viscosity of gels according to embodiments of the instant disclosure;

FIG. 5 is a graphical representation showing the effect of pH on viscosity of gels according to embodiments of the instant disclosure;

FIG. 6 is a graphical representation showing the effect of PHPA concentration on the complex viscosity of gels according to embodiments of the instant disclosure;

FIG. 7 is a graphical representation showing the effect of TEPA concentration on the complex viscosity of gels according to embodiments of the instant disclosure;

FIG. 8 is a graphical representation comparing gels according to embodiments of the instant disclosure with comparative gels;

FIG. 9 is a graphical representation comparing gels according to embodiments of the instant disclosure with comparative gels;

FIG. 10 is a graphical representation showing rheological profiles of gels according to embodiments of the instant disclosure; and

FIG. 11 is a graphical representation showing rheological profiles of gels according to embodiments of the instant disclosure.

### DETAILED DESCRIPTION

At the outset, it should be noted that in the development of any such actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary and this detailed description, each numerical value should be read once as modified by the term “about” (unless already expressly so modified), and then read again as not so modified unless otherwise indicated in context. Also, in the summary and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possessed knowledge of the entire range and all points within the range.

As used in the specification and claims, “near” is inclusive of “at.”

The following definitions are provided in order to aid those skilled in the art in understanding the detailed description.

The term “treatment”, or “treating”, refers to any subterranean operation that uses a fluid in conjunction with a desired function and/or for a desired purpose. The term “treatment”, or “treating”, does not imply any particular action by the fluid.

The term “fracturing” refers to the process and methods of breaking down a geological formation and creating a fracture, i.e. the rock formation around a well bore, by pumping fluid at very high pressures (pressure above the determined closure pressure of the formation), in order to increase production rates from or injection rates into a hydrocarbon reservoir. The fracturing methods otherwise use conventional techniques known in the art.

As used herein, the new numbering scheme for the Periodic Table Groups are used as in Chemical and Engineering News, 63(5), 27 (1985).

As used herein, the term “liquid composition” or “liquid medium” refers to a material which is liquid under the conditions of use. For example, a liquid medium may refer to water, and/or an organic solvent which is above the freezing point and below the boiling point of the material at a particular pressure. A liquid medium may also refer to a supercritical fluid.

As used herein, the term “polymer” or “oligomer” is used interchangeably unless otherwise specified, and both refer to homopolymers, copolymers, interpolymers, terpolymers, and the like. Likewise, a copolymer may refer to a polymer comprising at least two monomers, optionally with other monomers. When a polymer is referred to as comprising a monomer, the monomer is present in the polymer in the polymerized form of the monomer or in the derivative form of the monomer. However, for ease of reference the phrase comprising the (respective) monomer or the like is used as shorthand.

As used herein, the term gel refers to a solid or semi-solid, jelly-like composition that can have properties ranging from soft and weak to hard and tough. The term “gel” refers to a substantially dilute crosslinked system, which exhibits no flow when in the steady-state, which by weight is mostly liquid, yet behaves like solids due to a three-dimensional crosslinked network within the liquid. It is the crosslinks within the fluid that give a gel its structure (hardness) and contribute to stickiness. Accordingly, gels are a dispersion of molecules of a liquid within a solid in which the solid is the continuous phase and the liquid is the discontinuous phase. In an embodiment, a gel is considered to be present when the Elastic Modulus G′ is larger than the Viscous Modulus G″, when measured using an oscillatory shear rheometer (such as a Bohlin CVO 50) at a frequency of 1 Hz and at 20° C. The measurement of these moduli is well known to one of minimal skill in the art, and is described in An Introduction to Rheology, by H. A. Barnes, J. F. Hutton, and K. Walters, Elsevier, Amsterdam (1997), which is fully incorporated by reference herein.

As used herein, the term “dehydrating” as in “dehydrating a gel” refers to removing at least a portion of the solvent present in the gel to produce a gel concentrate. Accordingly, as used herein the term “dehydrating” may refer to removal of water or whatever solvent is present in the gel. Dehydrating or other solvent removal may be accomplished by the application of heat, reduced pressure, freeze-drying, or any combination thereof.

As used herein, the term “freeze-drying” refers to the process also known in the art as lyophilization, lyophilization or cryodesiccation, which is a dehydration process in which the temperature of a material is lowered (e.g., freezing the material) and then surrounding pressure is reduced to allow the frozen water in the material to sublimate directly from the solid phase to the gas phase.

The term polyacrylamide refers to pure polyacrylamide homopolymer or copolymer with near zero amount of acrylate groups, a partially hydrolyzed polyacrylamide polymer or copolymer with a mixture of acrylate groups and acrylamide groups formed by hydrolysis and copolymers comprising acrylamide, acrylic acid, and/or other monomers. Hydrolysis of acrylamide to acrylic acid proceeds with elevated temperatures and is enhanced by acidic or basic conditions. The reaction product is ammonia, which will increase the pH of acidic or neutral solutions. Except for severe conditions, hydrolysis of polyacrylamide tends to stop near 66%, representing the point where each acrylamide is sandwiched between two acrylate groups and steric hindrance restricts further hydrolysis. Polyacrylic acid is formed from acrylate monomer and is equivalent to 100% hydrolyzed polyacrylamide.

In an embodiment, a gel comprises greater than or equal to about 0.5 wt % polyacrylamide crosslinked with a non-metallic crosslinker. In an embodiment, the non-metallic crosslinker comprises a polyamine having a molecular weight of less than 500 g/mol.

Accordingly, the non-metallic crosslinkers referred to herein do not include metals, but are instead organic molecules, polymers, or the like. In an embodiment, the non-metallic crosslinker comprises a polyamine. A non-metallic crosslinker comprising a polyamine, also referred to herein as a polyamine crosslinker, is defined for purposes herein to include an organic compound having two or more primary, secondary and/or tertiary amino functional groups. Polyamine crosslinkers include both small molecules, i.e., having a molecular weight of less than 500 g/mol, and/or oligomeric and/or polymeric species having a weight average molecular weight of greater than or equal to about 1,000 g/mol, which comprise a plurality of primary, secondary and/or tertiary amine functional groups.

In an embodiment, polyamine crosslinkers include aliphatic polyamines including ethylenediamine, propylenediamine, butylenediamine, and hexamethylenediamine, alicyclic polyamines such as, for example, isophoronediamine, piperazine, tetraethylenepentamine (TEPA), pentaethylenehexamine (PEHA), 1,3-diaminopropane, diethylenetriamine, triethylenetriamine, tetraethylenepentamine, diethylene triamine, tetraethylmethylenediamine, triethylenetetraamine, and the like. Polyamines may also include biologically produced polyamines. Examples include putrescine, cadaverine, spermidine, spermine, and the like. Polyamines may further include cyclic amines. Examples include 1,4,7,10-tetraazacyclododecane, and the like.

In an embodiment, the polyamine may include aromatic polyamines, which are defined for purposes herein to be organic molecules having at least two amino groups directly and/or indirectly bonded to an aromatic ring. As used herein, the phrase “indirectly bonded to the aromatic ring” is defined to include an amino group bonded to the aromatic ring via a hydrocarbyl group. Further, aromatic polyamines include, for example, monocyclic aromatic polyamines having at least two amino groups bonded to one aromatic ring or a polycyclic aromatic polyamine having at least two aminophenyl groups each having at least one amino group bonded to one aromatic ring.

Examples of monocyclic aromatic polyamines include phenylenediamine, tolylenediamine, diethyltoluenediamine, and dimethylthiotoluenediamine wherein amino groups are directly bonded to an aromatic ring; and xylylenediamine wherein amino groups are bonded to an aromatic ring via a lower alkylene group. Further, the polycyclic aromatic polyamines may include a poly(aminobenzene) having at least two aminophenyl groups directly bonded to each other or a compound having at least two aminophenyl groups bonded via a lower alkylene group or an alkylene oxide group. Also included are diaminodiphenylalkanes having two aminophenyl groups bonded to each other via an alkylene group having from 1 to 10 carbons. Examples include 4,4′-diaminodiphenylmethane and/or derivatives thereof.

In an embodiment, the polyamine crosslinker may include a polymeric polyamine, including polyethylene polyamines, polyalkyleneimine, polyalkylenepolyamines, polyoxyalkylene polyamines, and the like. Examples of polymeric polyamines include polyethyleneimines, polypropyleneimines, polypyrrole, polyaniline, and the like.

In an embodiment, the gel comprises polyacrylamide crosslinked with a non-metallic crosslinker, the gel comprising greater than 0.5 wt % polyacrylamide crosslinked with a non-metallic crosslinker comprising a polyamine, the polyamine having a molecular weight of less than 500 g/mol.

In an embodiment, non-metallic crosslinker is selected from the group consisting of: tetraethylenepentamine, pentaethylenehexamine, 1,3-diaminopropane, diethylenetriamine, triethylenetriamine, tetraethylenepentamine, diethylene triamine, tetraethylmethylenediamine, triethylenetetraamine, putrescine, cadaverine, spermidine, spermine, 1,4,7,10-tetraazacyclododecane, polyethyleneimines, polypropyleneimines, polypyrrole, polyaniline, ethylenediamine, propylenediamine, butylenediamine, hexamethylenediamine, phenylenediamine, tolylenediamine, diethyltoluenediamine, dimethylthiotoluenediamine xylylenediamine, and a combination thereof.

In an embodiment, the non-metallic cross linker is tetraethylenepentamine, pentaethylenehexamine, or a combination thereof.

In an embodiment, the polyacrylamide has a weight average molecular weight of greater than or equal to about 0.5 million g/mol, or the polyacrylamide has a weight average molecular weight from about 1 million to about 20 million g/mol.

In an embodiment, the polyacrylamide is a partially hydrolyzed polyacrylamide having a degree of hydrolysis of from 0 or 0.01 wt % up to less than or equal to about 40 wt %, or from 0 or 0.05 wt % up to less than or equal to about 20 wt %, or from 0 or 0.1 wt % up to less than or equal to about 10 wt %.

In an embodiment, the gel comprises polyacrylamide crosslinked with a non-metallic crosslinker wherein the polyacrylamide is present in the gel at a concentration of greater than or equal to about 1 wt %, or greater than or equal to about 2 wt % and less than or equal to about 10 wt %, based on the total weight of the gel.

In an embodiment, the gel comprises polyacrylic acid, which is essentially 100% hydrolyzed polyacrylamide.

In an embodiment, the gel comprises polyacrylamide crosslinked with a non-metallic crosslinker wherein the concentration of the non-metallic crosslinker in the gel is greater than or equal to about 0.01 wt %, or greater than or equal to about 0.05 wt %, or greater than or equal to about 0.1 wt %, or greater than or equal to about 0.5 wt %, or greater than or equal to about 1 wt %, or greater than or equal to about 5 wt %, or greater than or equal to about 10 wt %, based on the total amount of the gel present.

In an embodiment, the gel has a pH of less than or equal to about 3, or less than or equal to about 2, or less then or equal to about 1, or the gel has a pH of greater than or equal to about 9, or greater than or equal to about 10, or greater than or equal to about 11, or greater than or equal to about 12, wherein the gel pH is defined as the pH of a 5% combination of the gel in water. In an alternative embodiment, the gel pH is defined as the pH as determined using a moistened pH probe in contact with the gel, e.g., moistened pH indicator paper. In an embodiment, the gel has a pH of less than or equal to about 3, or greater than or equal to about 9.

In an embodiment, the gel according to the present disclosure has a complex viscosity of greater than or equal to about 100 Pa·s at less than or equal to about 0.01 Hz, when determined according to methods known to one of minimal skill in the art.

In an embodiment, the difference between the Elastic Modulus G′ and the Viscous Modulus G″ of the gel, referred to herein as G′-G″, is greater than or equal to about 0.10, or greater than or equal to about 1, or greater than or equal to about 10, or greater than or equal to about 100, or greater than or equal to about 1000 Pa·s.

In an embodiment, the gel has a complex viscosity of greater than or equal to about 10, or greater than or equal to about 50, or greater than or equal to about 100, or greater than or equal to about 500, or greater than or equal to about 1000 Pa·s when determined at 0.01 Hz at 20° C.

In an embodiment, a method to produce a gel comprises contacting a composition comprising greater than about 0.5 wt % polyacrylamide with a non-metallic crosslinker comprising a polyamine having a molecular weight of less than 500 g/mol, at a pH of greater than or equal to about 9, or less than or equal to about 3, at a temperature and for a period of time sufficient to produce the gel. In an embodiment, the polyacrylamide concentration in the gel is greater than or equal to about 0.5 wt %, and the concentration of the non-metallic crosslinker in the gel is greater than or equal to about 0.01 wt %, based on the total weight of the gel.

In an embodiment, the concentration of the polyacrylamide in the polyacrylamide composition which is contacted with the non-metallic crosslinker is higher than the concentration of the polyacrylamide concentration in the gel produced. In an embodiment, the concentration of the polyacrylamide in the polyacrylamide composition is greater than about 0.5 wt %, or greater than about 1 wt %, or greater than about 2 wt %, or greater than about 3 wt %, or greater than about 4 wt %, or greater than about 5 wt %, based on the total weight of the polyacrylamide composition.

In an embodiment, the composition comprising greater than about 0.5 wt % polyacrylamide is a solution, dispersion, or slurry, or an aqueous solution, an aqueous dispersion, an emulsion, or an aqueous slurry, wherein the polyacrylamide is at least partially dissolved in the solvent. In an embodiment, the non-metallic crosslinker is a solid, a neat liquid, or a solution, a dispersion, an emulsion, or a slurry, or an aqueous solution, an aqueous dispersion or an aqueous slurry when contacted with the polyacrylamide composition.

In an embodiment, the composition comprising greater than about 0.5 wt % polyacrylamide is contacted with the non-metallic crosslinker while mixing, stirring, under shear, while being agitated, and/or the like. In an embodiment, the composition comprising greater than about 0.5 wt % polyacrylamide is contacted with the non-metallic crosslinker at a temperature of greater than or equal to about 3° C., or at a temperature of greater than or equal to about 10° C., or at a temperature of greater than or equal to about 20° C., or at a temperature of greater than or equal to about 30° C., or at a temperature of greater than or equal to about 40° C., or at a temperature of greater than or equal to about 50° C., or at a temperature of greater than or equal to about 60° C., or at a temperature of greater than or equal to about 70° C., or at a temperature of greater than or equal to about 80° C., for a period of time of about 1 minute to about 30 days, or for a period of time of about 1 minute to about 24 hours, about 5 minutes to about 1000 minutes, or any combination thereof.

In an embodiment, a method to produce a gel concentrate comprises removing at least a portion of a solvent from a gel according to the instant disclosure to produce the gel concentrate. In an embodiment, the gel is produced by contacting a composition comprising greater than about 0.5 wt % polyacrylamide at least partially dissolved in a solvent with a non-metallic crosslinker comprising a polyamine having a molecular weight of less than 500 g/mol, at a pH of greater than or equal to about 9, at a temperature and for a period of time sufficient to produce a gel.

In an embodiment, the gel solvent comprises water, and removing at least a portion of the solvent from the gel comprises freeze drying.

In an embodiment, the gel concentrate is a solid. In an embodiment, the gel concentrate is a free-flowing solid. In and embodiment, the gel concentrate comprises less than or equal to about 5 wt %, or less than or equal to about 1 wt % solvent. In and embodiment, the gel concentrate comprises less than or equal to about 5 wt %, or less than or equal to about 1 wt % water. In an embodiment, the particle size of the gel concentrate may be reduced to facilitate subsequent rehydration and thus reconstitution of the gel.

In an embodiment, a method to produce a reconstituted gel comprises contacting a gel concentrate according to an embodiment of the instant disclosure with a solvent at a pH, at a temperature and for a period of time sufficient to produce a reconstituted gel from the gel concentrate, wherein the gel concentrate comprises polyacrylamide crosslinked with a non-metallic crosslinker, and wherein the non-metallic crosslinker comprises a polyamine having a molecular weight of less than 500 g/mol. In an embodiment, a method to produce a reconstituted gel may further comprise agitating the gel concentrate in contact with the solvent. In an embodiment, the reconstitution solvent is essentially the same as the solvent used to initially produce the gel from which the gel concentrate was produced. In an embodiment, the reconstitution solvent is different than the solvent used to initially produce the gel from which the gel concentrate was produced. In an embodiment, the reconstitution pH is essentially the same as the pH used to initially produce the gel from which the gel concentrate was produced. In an embodiment, the reconstitution pH is different than the pH used to initially produce the gel from which the gel concentrate was produced.

In an embodiment, the difference between the Elastic Modulus G′ and the Viscous Modulus G″ of the reconstituted gel, is greater than or equal to about 90% of the difference between the Elastic Modulus G′ and the Viscous Modulus G″ of the gel from which the gel concentrate was produced, when determined under essentially identical conditions of concentration, solvent, temperature, and the like. In an embodiment, the difference between the Elastic Modulus G′ and the Viscous Modulus G″ of the reconstituted gel, is greater than or equal to about 0.10, or greater than or equal to about 1, or greater than or equal to about 10, or greater than or equal to about 100, or greater than or equal to about 1000 Pa·s.

In an embodiment, the complex viscosity of the reconstituted gel is greater than or equal to about 90% of the complex viscosity of the gel from which the gel concentrate was produced, when determined under essentially identical conditions of concentration, solvent, temperature, and the like. In an embodiment, the reconstituted gel has a complex viscosity of greater than or equal to about 10, or greater than or equal to about 50, or greater than or equal to about 100, or greater than or equal to about 500, or greater than or equal to about 1000 Pa·s when determined at 0.01 Hz at 20° C.

In an embodiment, the gel absorbs water when placed in contact with an aqueous solution. In an embodiment, the gel in contact with water uptakes greater than or equal to about 100% by weight of water, or greater than or equal to about 200% by weight of water.

In an embodiment, the gel is formed at a pH of greater than or equal to about 9 and remains as a gel when the pH of the gel is subsequently lowered below 9, or when the pH of the gel is lowered below about 7, or when the pH of the gel is lowered below about 5, or below about 3. In an embodiment, the gel remains a gel upon dilution of the gel in a solvent, wherein the gel is diluted from 1:0.1 gel to solvent to 1:1000 gel to solvent. In an embodiment, the gels retain essentially all of the same physical properties (i.e., are stable) at a temperature of greater than or equal to about 20° C., and less than or equal to about 150° C., or less than or equal to about 120° C., or less than or equal to about 110° C., or less than or equal to about 100° C., or less than or equal to about 90° C. Accordingly, in an embodiment, the gels according to the instant disclosure are temperature stable, non-reversible once formed, pH stable once formed, or a combination thereof.

In an embodiment, a method of treating a wellbore comprises injecting a composition comprising a gel according to the instant disclosure into a wellbore. In an embodiment, a method of treating a wellbore comprises injecting a composition comprising a gel into a wellbore, wherein the gel comprises greater than or equal to about 0.5 wt % polyacrylamide crosslinked with a non-metallic crosslinker comprising a polyamine having a molecular weight of less than 500 g/mol. In an embodiment, a method of treating a wellbore comprises forming a gel according to an embodiment of the instant disclosure and subsequently injecting the pre-formed gel into the wellbore.

In an embodiment, a method of treating a wellbore comprises injecting a composition comprising greater than about 0.5 wt % polyacrylamide into a wellbore; injecting a composition comprising a non-metallic crosslinker comprising a polyamine having a molecular weight of less than 500 g/mol into the wellbore, and optionally injecting a pH adjusting fluid into the wellbore in an amount sufficient to produce a downhole solution pH of greater than or equal to about 9 or less than or equal to about 3, to produce a gel in-situ. As used herein, a gel produced “in-situ” is defined as a gel produced within the wellbore or the surrounding strata. In an embodiment, the composition comprising greater than about 0.5 wt % polyacrylamide, the composition comprising a non-metallic crosslinker, and the pH adjustment fluid, which used, are injected into the wellbore separately, simultaneously, or any combination thereof. Accordingly, in an embodiment, the composition comprising greater than about 0.5 wt % polyacrylamide and the composition comprising the non-metallic crosslinker may be combined and then injected into the well bore either prior to or after the injection of the pH adjustment fluid into the wellbore. In an embodiment, the composition comprising the polyacrylamide and the pH adjustment fluid may be combined and then injected into the well bore either prior to or after the injection of the composition comprising the non-metallic crosslinker into the wellbore. In an embodiment, the composition comprising the non-metallic crosslinker and the pH adjustment fluid may be combined and then injected into the well bore either prior to or after the injection of the composition comprising the polyacrylamide into the wellbore.

In an embodiment, the pH adjusting fluid is an aqueous solution comprising a base, an acid, a pH buffer, or any combination thereof. In an embodiment, the pH adjusting fluid comprises sodium hydroxide, sodium carbonate, sulfuric acid, hydrochloric acid, an organic acid, carbon dioxide, or any combination thereof, which may be neat or which may be at least partially dissolved in a solvent.

In an embodiment, a method of treating a wellbore comprises injecting a composition comprising a gel concentrate according to the instant disclosure into a wellbore. In an embodiment, a method of treating a wellbore comprises injecting a composition comprising a gel concentrate into a wellbore, wherein the gel concentrate comprises polyacrylamide crosslinked with a non-metallic crosslinker, wherein the non-metallic crosslinker comprises a polyamine having a molecular weight of less than 500 g/mol.

In an embodiment, a wellbore treatment fluid comprises a gel, a gel concentrate, and/or a reconstituted gel according to the instant disclosure. In an embodiment, a wellbore treatment fluid comprises a gel, the gel comprising greater than or equal to about 0.5 wt % polyacrylamide crosslinked with a non-metallic crosslinker, the non-metallic crosslinker comprising a polyamine having a molecular weight of less than 500 g/mol.

In an embodiment, a well treatment fluid comprises a first composition comprising greater than about 0.5 wt % polyacrylamide; and a second composition comprising a non-metallic crosslinker comprising a polyamine having a molecular weight of less than 500 g/mol. In an embodiment, the well treatment fluid may further comprises a pH adjustment composition, the pH adjustment fluid comprising an acid, a base, or a buffer at least partially dissolved in a solvent.

In an embodiment, a well treatment fluid comprises a gel concentrate, the gel concentrate comprising polyacrylamide crosslinked with a non-metallic crosslinker, wherein the non-metallic crosslinker comprises a polyamine having a molecular weight of less than 500 g/mol.

In an embodiment, the compositions and/or the gels may comprise water, i.e., an aqueous gel, and/or an organic solvent. The organic solvent may be selected from the group consisting of diesel oil, kerosene, paraffinic oil, crude oil, LPG, toluene, xylene, ether, ester, mineral oil, biodiesel, vegetable oil, animal oil, and mixtures thereof. Specific examples of suitable organic solvent include acetone, acetonitrile, benzene, 1-butanol, 2-butanol, 2-butanone, t-butyl alcohol, carbon tetrachloride, chlorobenzene, chloroform, cyclohexane, 1,2-dichloroethane, diethyl ether, diethylene glycol, diglyme (diethylene glycol dimethyl ether), 1,2-dimethoxy-ethane (glyme, DME), dimethylether, dibutylether, dimethyl-formamide (DMF), dimethyl sulfoxide (DMSO), dioxane, ethanol, ethyl acetate, ethylene glycol, glycerin, heptanes, Hexamethylphosphoramide (HMPA), Hexamethylphosphorous triamide (HMPT), hexane, methanol, methyl t-butyl ether (MTBE), methylene chloride, N-methyl-2-pyrrolidinone (NMP), nitromethane, pentane , Petroleum ether (ligroine), 1-propanol, 2-propanol, pyridine, tetrahydrofuran (THF), toluene, triethyl amine, o-xylene, m-xylene, p-xylene.

Further solvents include aromatic petroleum cuts, terpenes, mono-, di- and tri-glycerides of saturated or unsaturated fatty acids including natural and synthetic triglycerides, aliphatic esters such as methyl esters of a mixture of acetic, succinic and glutaric acids, aliphatic ethers of glycols such as ethylene glycol monobutyl ether, minerals oils such as vaseline oil, chlorinated solvents like 1,1,1-trichloroethane, perchloroethylene and methylene chloride, deodorized kerosene, solvent naphtha, paraffins (including linear paraffins), isoparaffins, olefins (especially linear olefins) and aliphatic or aromatic hydrocarbons (such as toluene). Terpenes are suitable, including d-limonene, 1-limonene, dipentene (also known as 1-methyl-4-(1-methylethenyl)-cyclohexene), myrcene, alpha-pinene, linalool and mixtures thereof.

Further exemplary organic liquids include long chain alcohols (monoalcohols and glycols), esters, ketones (including diketones and polyketones), nitrites, amides, amines, cyclic ethers, linear and branched ethers, glycol ethers (such as ethylene glycol monobutyl ether), polyglycol ethers, pyrrolidones like N-(alkyl or cycloalkyl)-2-pyrrolidones, N-alkyl piperidones, N,N-dialkyl alkanolamides, N,N,N′,N′-tetra alkyl ureas, dialkylsulfoxides, pyridines, hexaalkylphosphoric triamides, 1,3-dimethyl-2-imidazolidinone, nitroalkanes, nitro-compounds of aromatic hydrocarbons, sulfolanes, butyrolactones, and alkylene or alkyl carbonates. These include polyalkylene glycols, polyalkylene glycol ethers like mono(alkyl or aryl)ethers of glycols, mono(alkyl or aryl)ethers of polyalkylene glycols and poly(alkyl and/or aryl)ethers of polyalkylene glycols, monoalkanoate esters of glycols, monoalkanoate esters of polyalkylene glycols, polyalkylene glycol esters like poly(alkyl and/or aryl) esters of polyalkylene glycols, dialkyl ethers of polyalkylene glycols, dialkanoate esters of polyalkylene glycols, N-(alkyl or cycloalkyl)-2-pyrrolidones, pyridine and alkylpyridines, diethylether, dimethoxyethane, methyl formate, ethyl formate, methyl propionate, acetonitrile, benzonitrile, dimethylformamide, N-methylpyrrolidone, ethylene carbonate, dimethyl carbonate, propylene carbonate, diethyl carbonate, ethylmethyl carbonate, and dibutyl carbonate, lactones, nitromethane, and nitrobenzene sulfones. The organic liquid may also be selected from the group consisting of tetrahydrofuran, dioxane, dioxolane, methyltetrahydrofuran, dimethylsulfone, tetramethylene sulfone and thiophen.

In an embodiment, the well treatment fluid, also referred to as the carrier fluid, may include any base fracturing fluid understood in the art. Some non-limiting examples of carrier fluids include hydratable gels (e.g. guars, poly-saccharides, xanthan, hydroxy-ethyl-cellulose, etc.), a crosslinked hydratable gel, a viscosified acid (e.g. gel-based), an emulsified acid (e.g. oil outer phase), an energized fluid (e.g. an N2 or CO2 based foam), and an oil-based fluid including a gelled, foamed, or otherwise viscosified oil. Additionally, the carrier fluid may be a brine, and/or may include a brine.

In an embodiment, the well treatment fluid may include a viscosifying agent, which may include a viscoelastic surfactant (VES). The VES may be selected from the group consisting of cationic, anionic, zwitterionic, amphoteric, nonionic and combinations thereof. Some non-limiting examples are those cited in U.S. Pat. Nos. 6,435,277 (Qu et al.) and 6,703,352 (Dahayanake et al.), each of which are incorporated herein by reference. The viscoelastic surfactants, when used alone or in combination, are capable of forming micelles that form a structure in an aqueous environment that contribute to the increased viscosity of the fluid (also referred to as “viscosifying micelles”). These fluids are normally prepared by mixing in appropriate amounts of VES suitable to achieve the desired viscosity. The viscosity of VES fluids may be attributed to the three dimensional structure formed by the components in the fluids. When the concentration of surfactants in a viscoelastic fluid significantly exceeds a critical concentration, and in most cases in the presence of an electrolyte, surfactant molecules aggregate into species such as micelles, which can interact to form a network exhibiting viscous and elastic behavior.

In general, particularly suitable zwitterionic surfactants have the formula:

RCONH—(CH₂)ₐ(CH₂CH₂O)ₘ(CH₂)_{b}—N⁺(CH₃)₂—(CH₂)_{a′}(CH₂CH₂O)_{m′}(CH₂)_{b′}COO⁻

in which R is an alkyl group that contains from about 11 to about 23 carbon atoms which may be branched or straight chained and which may be saturated or unsaturated; a, b, a′, and b′ are each from 0 to 10 and m and m′ are each from 0 to 13; a and b are each 1 or 2 if m is not 0 and (a+b) is from 2 to 10 if m is 0; a′ and b′ are each 1 or 2 when m′ is not 0 and (a′+b′) is from 1 to 5 if m is 0; (m+m′) is from 0 to 14; and CH₂CH₂O may also be OCH₂CH₂. In some embodiments, a zwitterionic surfactant of the family of betaine is used.

Exemplary cationic viscoelastic surfactants include the amine salts and quaternary amine salts disclosed in U.S. Pat. Nos. 5,979,557, and 6,435,277 which are hereby incorporated by reference. Examples of suitable cationic viscoelastic surfactants include cationic surfactants having the structure:

R¹N⁺(R²)(R³)(R⁴)X⁻

in which R¹ has from about 14 to about 26 carbon atoms and may be branched or straight chained, aromatic, saturated or unsaturated, and may contain a carbonyl, an amide, a retroamide, an imide, a urea, or an amine; R², R³, and R⁴ are each independently hydrogen or a C₁ to about C₆ aliphatic group which may be the same or different, branched or straight chained, saturated or unsaturated and one or more than one of which may be substituted with a group that renders the R², R³, and R⁴ group more hydrophilic; the R², R³, and R⁴ groups may be incorporated into a heterocyclic 5- or 6-member ring structure which includes the nitrogen atom; the R², R³, and R⁴ groups may be the same or different; R¹, R², R³, and/or R⁴ may contain one or more ethylene oxide and/or propylene oxide units; and X— is an anion. Mixtures of such compounds are also suitable. As a further example, R¹ is from about 18 to about 22 carbon atoms and may contain a carbonyl, an amide, or an amine, and R², R³, and R⁴ are the same as one another and contain from 1 to about 3 carbon atoms.

Amphoteric viscoelastic surfactants are also suitable. Exemplary amphoteric viscoelastic surfactant systems include those described in U.S. Pat. No. 6,703,352, for example amine oxides. Other exemplary viscoelastic surfactant systems include those described in U.S. Pat. Nos. 6,239,183; 6,506,710; 7,060,661; 7,303,018; and 7,510,009 for example amidoamine oxides. These references are hereby incorporated in their entirety. Mixtures of zwitterionic surfactants and amphoteric surfactants are suitable. An example is a mixture of about 13% isopropanol, about 5% 1-butanol, about 15% ethylene glycol monobutyl ether, about 4% sodium chloride, about 30% water, about 30% cocoamidopropyl betaine, and about 2% cocoamidopropylamine oxide.

The viscoelastic surfactant system may also be based upon any suitable anionic surfactant. In some embodiments, the anionic surfactant is an alkyl sarcosinate. The alkyl sarcosinate can generally have any number of carbon atoms. Alkyl sarcosinates can have about 12 to about 24 carbon atoms. The alkyl sarcosinate can have about 14 to about 18 carbon atoms. Specific examples of the number of carbon atoms include 12, 14, 16, 18, 20, 22, and 24 carbon atoms. The anionic surfactant is represented by the chemical formula:

R¹CON(R²)CH₂X

wherein R¹ is a hydrophobic chain having about 12 to about 24 carbon atoms, R² is hydrogen, methyl, ethyl, propyl, or butyl, and X is carboxyl or sulfonyl. The hydrophobic chain can be an alkyl group, an alkenyl group, an alkylarylalkyl group, or an alkoxyalkyl group.

Specific examples of the hydrophobic chain include a tetradecyl group, a hexadecyl group, an octadecentyl group, an octadecyl group, and a docosenoic group. Examples include hydrophobic chains derived from a carboxylic acid moiety having from 10 to 30 carbon atoms, or from 12 to 22 carbon atoms. In an embodiment, the carboxylic acid moieties are derived from carboxylic acids selected from the group consisting of capric acid, undecylic acid, lauric acid, tridecylic acid, myristic acid, pentadecylic acid, palmitic acid, margaric acid, stearic acid, nonadecylic acid, arachidic acid, heneicosylic acid, behenic acid, tricosylic acid, lignoceric acid, pentacosylic acid, cerotic acid, heptacosylic acid, montanic acid, nonacosylic acid, melissic acid, myristoleic acid, palmitoleic acid, sapienic acid, oleic acid, elaidic acid, vaccenic acid, linoleic acid, linoelaidic acid, α-linolenic acid, arachidonic acid, eicosapentaenoic acid, erucic acid, docosahexaenoic acid, resinolic acid, and a combination thereof.

In an embodiment, the carrier fluid includes an acid, a chelant, or both. The fracture may be a traditional hydraulic bi-wing fracture, but in certain embodiments may be an etched fracture and/or wormholes such as developed by an acid treatment. The carrier fluid may include hydrochloric acid, hydrofluoric acid, ammonium bifluoride, formic acid, acetic acid, lactic acid, glycolic acid, maleic acid, tartaric acid, sulfamic acid, malic acid, citric acid, methyl-sulfamic acid, chloro-acetic acid, an amino-poly-carboxylic acid, 3-hydroxypropionic acid, a poly-amino-poly-carboxylic acid, and/or a salt of any acid. In certain embodiments, the carrier fluid includes a poly-amino-poly-carboxylic acid, and is a trisodium hydroxyl-ethyl-ethylene-diamine triacetate, mono-ammonium salts of hydroxyl-ethyl-ethylene-diamine triacetate, and/or mono-sodium salts of hydroxyl-ethyl-ethylene-diamine tetra-acetate. The selection of any acid as a carrier fluid depends upon the purpose of the acid—for example formation etching, damage cleanup, removal of acid-reactive particles, etc., and further upon compatibility with the formation, compatibility with fluids in the formation, and compatibility with other components of the fracturing slurry and with spacer fluids or other fluids that may be present in the wellbore. The selection of an acid for the carrier fluid is understood in the art based upon the characteristics of particular embodiments and the disclosures herein.

The composition may include a particulate blend made of proppant. Proppant selection involves many compromises imposed by economical and practical considerations. Criteria for selecting the proppant type, size, size distribution in multimodal proppant selection, and concentration is based on the needed dimensionless conductivity, and can be selected by a skilled artisan. Such proppants can be natural or synthetic (including but not limited to glass beads, ceramic beads, sand, and bauxite), coated, or contain chemicals; more than one can be used sequentially or in mixtures of different sizes or different materials. The proppant may be resin coated (curable), or pre-cured resin coated. Proppants and gravels in the same or different wells or treatments can be the same material and/or the same size as one another and the term proppant is intended to include gravel in this disclosure. In some embodiments, irregular shaped particles may be used such as unconventional proppant. In general the proppant used will have an average particle size of from about 0.15 mm to about 4.76 mm (about 100 to about 4 U.S. mesh), or from about 0.15 mm to about 3.36 mm (about 100 to about 6 U.S. mesh), more or from about 0.15 mm to about 4.76 mm (about 100 to about 4 U.S. mesh), more particularly, but not limited to 0.25 to 0.42 mm (40/60 mesh), 0.42 to 0.84 mm (20/40 mesh), 0.84 to 1.19 mm (16/20), 0.84 to 1.68 mm (12/20 mesh) and 0.84 to 2.38 mm (8/20 mesh) sized materials. Normally the proppant will be present in the slurry in a concentration from about 0.12 to about 0.96 kg/L, or from about 0.12 to about 0.72 kg/L, or from about 0.12 to about 0.54 kg/L. Some slurries are used where the proppant is at a concentration up to 16 PPA (1.92 kg/L). If the slurry is foamed the proppant is at a concentration up to 20 PPA (2.4 kg/L). The slurry composition is not a cement slurry composition.

The composition may comprise particulate materials with defined particles size distribution. Examples of high solid content treatment fluid (HSCF) in which the degradeable latex may be employed are disclosed in U.S. Pat. No. 7,789,146; U.S. Pat. No. 7,784,541; US 2010/0155371; US 2010/0155372; US 2010/0243250; and US 2010/0300688; all of which are hereby incorporated herein by reference in their entireties.

The composition may further comprise a degradable material. In certain embodiments, the degradable material includes at least one of a lactide, a glycolide, an aliphatic polyester, a poly(lactide), a poly(glycolide), a poly(ε-caprolactone), a poly (orthoester), a poly(hydroxybutyrate), an aliphatic polycarbonate, a poly(phosphazene), and a poly(anhydride). In certain embodiments, the degradable material includes at least one of a poly(saccharide), dextran, cellulose, chitin, chitosan, a protein, a poly(amino acid), a poly(ethylene oxide), and a copolymer including poly(lactic acid) and poly (glycolic acid). In certain embodiments, the degradable material includes a copolymer including a first moiety which includes at least one functional group from a hydroxyl group, a carboxylic acid group, and a hydrocarboxylic acid group, the copolymer further including a second moiety comprising at least one of glycolic acid and lactic acid.

In some embodiments, the composition may optionally further comprise additional additives, including, but not limited to, acids, fluid loss control additives, gas, corrosion inhibitors, scale inhibitors, catalysts, clay control agents, biocides, friction reducers, combinations thereof and the like. For example, in some embodiments, it may be desired to foam the storable composition using a gas, such as air, nitrogen, or carbon dioxide.

The composition may be used for carrying out a variety of subterranean treatments, including, but not limited to, drilling operations, fracturing treatments, and completion operations (e.g., gravel packing). In some embodiments, the composition may be used in treating a portion of a subterranean formation. In certain embodiments, the composition may be introduced into a well bore that penetrates the subterranean formation as a treatment fluid. For example, the treatment fluid may be allowed to contact the subterranean formation for a period of time. In some embodiments, the treatment fluid may be allowed to contact hydrocarbons, formations fluids, and/or subsequently injected treatment fluids. After a chosen time, the treatment fluid may be recovered through the well bore. In certain embodiments, the treatment fluids may be used in fracturing treatments.

The method is also suitable for gravel packing, or for fracturing and gravel packing in one operation (called, for example frac and pack, frac-n-pack, frac-pack, STIMPAC (Trade Mark from Schlumberger) treatments, or other names), which are also used extensively to stimulate the production of hydrocarbons, water and other fluids from subterranean formations. These operations involve pumping the composition and propping agent/material in hydraulic fracturing or gravel (materials are generally as the proppants used in hydraulic fracturing) in gravel packing. In low permeability formations, the goal of hydraulic fracturing is generally to form long, high surface area fractures that greatly increase the magnitude of the pathway of fluid flow from the formation to the wellbore. In high permeability formations, the goal of a hydraulic fracturing treatment is typically to create a short, wide, highly conductive fracture, in order to bypass near-wellbore damage done in drilling and/or completion, to ensure good fluid communication between the reservoir and the wellbore and also to increase the surface area available for fluids to flow into the wellbore.

### Embodiments

Accordingly, the present disclosure provides the following embodiments:

A. A gel comprising, greater than or equal to about 0.5 wt % polyacrylamide crosslinked with a non-metallic crosslinker comprising a polyamine having a molecular weight of less than 500 g/mol.

B. The gel according to Embodiment A, wherein the gel comprises greater than or equal to about 0.01 wt % of the non-metallic crosslinker.

C. The gel according to Embodiment A or B, wherein the non-metallic crosslinker is selected from the group consisting of: tetraethylenepentamine, pentaethylenehexamine, 1,3-diaminopropane, diethylenetriamine, triethylenetriamine, tetraethylenepentamine, diethylene triamine, tetraethylmethylenediamine, triethylenetetraamine, putrescine, cadaverine, spermidine, spermine, 1,4,7,10-tetraazacyclododecane, polyethyleneimines, polypropyleneimines, polypyrrole, polyaniline, ethylenediamine, propylenediamine, butylenediamine, hexamethylenediamine, phenylenediamine, tolylenediamine, diethyltoluenediamine, dimethylthiotoluenediamine xylylenediamine, and a combination thereof.

D. The gel according to Embodiment A, B, or C, wherein the non-metallic cross linker is tetraethylenepentamine, pentaethylenehexamine, or a combination thereof.

E. The gel according to Embodiment A, B, C, or D, having a pH of less than or equal to about 3, or greater than or equal to about 9.

F. The gel according to Embodiment A, B, C, D, or E, having a complex viscosity of greater than or equal to about 100 Pa·s at less than or equal to about 0.01 Hz.

G. The gel according to Embodiment A, B, C, D, E, or F, wherein G′-G″ is greater than or equal to about 0.1 Pa·s wherein G′ and G″ are determined using an oscillatory shear rheometer at a frequency of 1 Hz and at 20° C.

H. A method to produce a gel comprising:
contacting a composition comprising greater than about 0.5 wt % polyacrylamide with a non-metallic crosslinker comprising a polyamine having a molecular weight of less than 500 g/mol, at a pH of greater than or equal to about 9, or less than or equal to about 3, at a temperature and for a period of time sufficient to produce the gel,
   wherein the polyacrylamide concentration in the gel is greater than or equal to about 0.5 wt %, and wherein the concentration of the non-metallic crosslinker in the gel is greater than or equal to about 0.01 wt %, based on the total weight of the gel.

I. The method of Embodiment H, wherein the amount of the non-metallic crosslinker contacted with the polyacrylamide is sufficient to produce a gel having a concentration of the polyamine in the gel of greater than or equal to about 0.1 wt %, based on the total weight of the gel.

J. The method of Embodiment H or I, wherein the non-metallic crosslinker is selected from the group consisting of: tetraethylenepentamine, pentaethylenehexamine, 1,3-diaminopropane, diethylenetriamine, triethylenetriamine, tetraethylenepentamine, diethylene triamine, tetraethylmethylenediamine, triethylenetetraamine, putrescine, cadaverine, spermidine, spermine, 1,4,7,10-tetraazacyclododecane, polyethyleneimines, polypropyleneimines, polypyrrole, polyaniline, ethylenediamine, propylenediamine, butylenediamine, hexamethylenediamine, phenylenediamine, tolylenediamine, diethyltoluenediamine, dimethylthiotoluenediamine xylylenediamine, and a combination thereof.

K. The method of Embodiment H, I, or J, wherein the non-metallic cross linker is tetraethylenepentamine, pentaethylenehexamine, or a combination thereof.

L. The method of Embodiment H, I, J, or K, wherein the temperature is greater than or equal to about 50° C.

M. A method to produce a gel concentrate comprising:
contacting a composition comprising greater than about 0.5 wt % polyacrylamide at least partially dissolved in a solvent with a non-metallic crosslinker comprising a polyamine having a molecular weight of less than 500 g/mol, at a pH of greater than or equal to about 9, at a temperature and for a period of time sufficient to produce a gel,
wherein the polyacrylamide concentration in the gel is greater than or equal to about 0.5 wt %, and wherein the concentration of the non-metallic crosslinker in the gel is greater than or equal to about 0.01 wt %, based on the total weight of the gel; and
removing at least a portion of the solvent from the gel to produce the gel concentrate.

N. The method of Embodiment M, wherein the solvent comprises water and removing at least a portion of the solvent from the gel comprises freeze drying.

O. The method of Embodiment M or N, wherein the non-metallic crosslinker is selected from the group consisting of: tetraethylenepentamine, pentaethylenehexamine, 1,3-diaminopropane, diethylenetriamine, triethylenetriamine, tetraethylenepentamine, diethylene triamine, tetraethylmethylenediamine, triethylenetetraamine, putrescine, cadaverine, spermidine, spermine, 1,4,7,10-tetraazacyclododecane, polyethyleneimines, polypropyleneimines, polypyrrole, polyaniline, ethylenediamine, propylenediamine, butylenediamine, hexamethylenediamine, phenylenediamine, tolylenediamine, diethyltoluenediamine, dimethylthiotoluenediamine xylylenediamine, and a combination thereof.

P. A method to produce a reconstituted gel comprising:
contacting a gel concentrate with a solvent at a pH, at a temperature and for a period of time sufficient to produce a reconstituted gel from the gel concentrate, wherein the gel concentrate comprises polyacrylamide crosslinked with a non-metallic crosslinker, and wherein the non-metallic crosslinker comprises a polyamine having a molecular weight of less than 500 g/mol.

Q. The method of Embodiment P, wherein the non-metallic crosslinker is selected from the group consisting of: tetraethylenepentamine, pentaethylenehexamine, 1,3-diaminopropane, diethylenetriamine, triethylenetriamine, tetraethylenepentamine, diethylene triamine, tetraethylmethylenediamine, triethylenetetraamine, putrescine, cadaverine, spermidine, spermine, 1,4,7,10-tetraazacyclododecane, polyethyleneimines, polypropyleneimines, polypyrrole, polyaniline, ethylenediamine, propylenediamine, butylenediamine, hexamethylenediamine, phenylenediamine, tolylenediamine, diethyltoluenediamine, dimethylthiotoluenediamine xylylenediamine, and a combination thereof.

R. A method of treating a wellbore comprising:
injecting a composition comprising a gel into a wellbore, wherein the gel comprises greater than or equal to about 0.5 wt % polyacrylamide crosslinked with a non-metallic crosslinker comprising a polyamine having a molecular weight of less than 500 g/mol.

S. A method of treating a wellbore comprising:
injecting a composition comprising greater than about 0.5 wt % polyacrylamide into a wellbore;
injecting a composition comprising a non-metallic crosslinker comprising a polyamine having a molecular weight of less than 500 g/mol into the wellbore, and
injecting a pH adjusting fluid into the wellbore in an amount sufficient to produce a downhole solution pH of greater than or equal to about 9 or less than or equal to about 3, to produce a gel in-situ, the in-situ gel comprising greater than or equal to about 0.5 wt % polyacrylamide crosslinked with greater than or equal to about 0.01 wt % of the non-metallic crosslinker,
wherein the composition comprising greater than about 0.5 wt % polyacrylamide, the composition comprising a non-metallic crosslinker, and the pH adjustment fluid are injected into the wellbore separately, simultaneously, or any combination thereof.

T. The method of Embodiment S, wherein the non-metallic crosslinker is selected from the group consisting of: tetraethylenepentamine, pentaethylenehexamine, 1,3-diaminopropane, diethylenetriamine, triethylenetriamine, tetraethylenepentamine, diethylene triamine, tetraethylmethylenediamine, triethylenetetraamine, putrescine, cadaverine, spermidine, spermine, 1,4,7,10-tetraazacyclododecane, polyethyleneimines, polypropyleneimines, polypyrrole, polyaniline, ethylenediamine, propylenediamine, butylenediamine, hexamethylenediamine, phenylenediamine, tolylenediamine, diethyltoluenediamine, dimethylthiotoluenediamine xylylenediamine, and a combination thereof.

U. A method of treating a wellbore comprising: injecting a composition comprising a gel concentrate into a wellbore, wherein the gel concentrate comprises polyacrylamide crosslinked with a non-metallic crosslinker, wherein the non-metallic crosslinker comprises a polyamine having a molecular weight of less than 500 g/mol.

V. The method of Embodiment U, wherein the non-metallic crosslinker is selected from the group consisting of: tetraethylenepentamine, pentaethylenehexamine, 1,3-diaminopropane, diethylenetriamine, triethylenetriamine, tetraethylenepentamine, diethylene triamine, tetraethylmethylenediamine, triethylenetetraamine, putrescine, cadaverine, spermidine, spermine, 1,4,7,10-tetraazacyclododecane, polyethyleneimines, polypropyleneimines, polypyrrole, polyaniline, ethylenediamine, propylenediamine, butylenediamine, hexamethylenediamine, phenylenediamine, tolylenediamine, diethyltoluenediamine, dimethylthiotoluenediamine xylylenediamine, and a combination thereof.

W. A well treatment fluid comprising a gel, the gel comprising greater than or equal to about 0.5 wt % polyacrylamide crosslinked with a non-metallic crosslinker, the non-metallic crosslinker comprising a polyamine having a molecular weight of less than 500 g/mol.

X. A well treatment fluid comprising a first composition comprising greater than about 0.5 wt % polyacrylamide; and a second composition comprising a non-metallic crosslinker comprising a polyamine having a molecular weight of less than 500 g/mol.

Y. The well treatment fluid of Embodiment X, further comprising a pH adjustment composition, the pH adjustment fluid comprising an acid, a base, or a buffer at least partially dissolved in a solvent.

Z. A well treatment fluid comprising a gel concentrate, the gel concentrate comprising polyacrylamide crosslinked with a non-metallic crosslinker, wherein the non-metallic crosslinker comprises a polyamine having a molecular weight of less than 500 g/mol.

### EXAMPLES

The following examples show that gels according to the instant disclosure may be formed at ambient temperature provided the solution has an alkaline pH, and may be formed at an acidic pH upon heating. In all cases, the formed gels appear to be very elastic and sticky in nature. The gels will absorb and swell when placed in water, uptaking more than 200% of their weight. Unlike the low pH interpolymer complexes discussed in the literature, the clear gels of the instant disclosure are irreversible to changes in pH, dilution, and have excellent high temperature stability. Gel formation can occur at ambient temperature or elevated temperature as long as the gel pH is sufficiently acidic or alkaline. The gel does not appear to be formed by hydrogen bonding and thus is not a complex as seen at low pH, but instead is the result of a non-reversible chemical reaction between the polyacrylamide and the non-metallic crosslinker.

Partially hydrolyzed polyacrylamide (PHPA) at 3% and tetraethylenepentamine (TEPA) and pentaethylenehexamine (PEHA) were both utilized as polyamine crosslinkers to form gels with PHPA. It has also been discovered that heating was not required if the pH was alkaline above about pH of 9, but a gel would form under acidic conditions of pH less than 3 if heated. It is speculated that the heating step generates alkalinity by further hydrolysis of the PHPA generating ammonia ions that raised the pH and initiated the gelation. Scanning Electron Microscopy (SEM) and phase contrast micrographs of dried gels according to the instant disclosure show gels having a linear, fibrous character to them and possibly form hollow vesicles.

Gels were also prepared with different molecular weights, concentrations and hydrolysis level of PHPA. For the non-metallic cross linker, various concentrations, pH, and temperature conditions with TEPA and PEHA as the low molecular weight crosslinkers (i.e., having a molecular weight of less than 500 g/mol) were evaluated.

Gels prepared with TEPA or PEHA are stable at high temperatures, e.g., up to and above 150° C., presumably because of the stabilizing effects of the amines with respect to oxygen degradation. Thus, the use of these low molecular weight polyamines offers a dual advantage of excellent gel formation and stability.

The data further shows the gel may be freeze dried to produce a gel concentrate, and later reconstituted by hydrating the gel concentrate particles to produce a reconstituted gel. The gels formed at different rates depending on pH, concentration of the PHPA, concentration of the polyamine crosslinker, and temperature. Accordingly, a delayed gelation for water control using gels according to the instant disclosure is possible. Other methods include the use of the instant gel particles as friction reducers, delayed viscosity booster in hydraulic fracturing, diverting agent in stimulation via viscosity and gel formation, temporary plug creation, water absorbing gel for water control, and a low viscosity cleanout fluid that generates viscosity downhole to lift sand and other solids to the surface.

In the examples, the method to produce the gels was to mix solutions of the subject partially hydrolyzed polyacrylamide (PHPA) with various polyamine crosslinkers and determine if a gel formed at ambient conditions and at several pH levels from acidic to basic. The solutions were observed for days to weeks for gel formation. When a gel formed, the gel was further characterized by visual observation, rheological methods and the effects of water or acidic solutions on the formed gel. Low pH gels were typically characterized by separating the free water that invariably formed from the gel portion and evaluating the gel portion.

### Gel Formation

The mixing procedure to produce the gels was to fully hydrate the PHPA in deionized water using an overhead stirrer running at 600 RPM. Powdered PHPA polymer was gradually added to the shoulder of the vortex over a 20 second period to avoid the formation of clumps or fisheyes. Stirring continued for about an hour or until all of the polymer particles had fully hydrated as seen by visual observation (i.e., were at least partially dissolved). Next, the non-metallic crosslinker was added directly to the PHPA composition and stirred continuously until it had fully dissolved. The pH of the mixture was measured before splitting the sample into several parts. Each part was then adjusted to the various levels of pH using 10% HCl or 10% NaOH solutions. The final pH was measured and recorded. The presence of gels was evaluated by periodic visual observation. As an example, the fluid with 3% PHPA and 5% TEPA was prepared as follows:

3 grams of PHPA were added to 97 grams of DI water under stirring and stirred until fully hydrated to give a true 3 wt % solution.

5 grams of TEPA were then added while stirring until fully dissolved. This gives a solution that is 2.85 wt % PHPA and 4.76 wt % TEPA, although it is referred to herein as 3% PHPA and 5% TEPA.

Next, the native pH of the mixture was determined.

The fluid was then separated into 4 equal parts and the pH adjusted to nominal values of 1, 3, and 9 using 10% HCl or 10% NaOH. The fourth part was the native pH sample.

### Rheological Characterization

Rheological testing was conducted at low temperature (less than 80° C.) using a Bohlin rheometer with 25 mm cup and bob operating under dynamic mode (frequency sweep at 10% strain). The elastic modulus G′, the viscous modulus G″, and the complex viscosity of the sample was determined using an oscillating rheometer according to standard methods known to one of minimal skill in the art.

When G′ is greater than G″ the existence of a gel was indicated. The magnitude of G′ was used to qualitatively quantify the gel strength. When G″ is larger than G′, this suggests a liquid is present and no gel has formed. The complex viscosity of the gel is comparable to the steady state viscosity since the gels formed herein followed the Cox-Merx rule.

A Grace 5600 model 50 viscometer was also used to generate data. Viscosity build of the gels were monitored by adding 50 mL of solution to the instrument sample cup, attaching the cup and applying nitrogen pressure of about 400 psi and then applying heat. As the temperature of the samples rose, the initially viscous fluid would typically decrease in viscosity (thermal thinning) until a certain point where gelation was initiated and then the viscosity would rise. Gelation extent was monitored by the final attained viscosity. It is important to note, once gelation occurred the measuring range of the viscometer was quickly exceeded. As is apparent to one of minimal skill in the art, the data present in some of the Figures shows minima and maxima which are merely artifacts of the measurement, and which do not represent the properties of the gels under the indicated conditions.

### Visual Observations

The results of the ambient screening for gel formation are shown in Table 1. For the listed PHPA polymers, the molecular weight and % hydrolysis are shown in parentheses in the first row of the heading and the concentration is noted. The second row of the heading shows the concentration of the non-metallic crosslinker. The nominal pH is shown to the left of the remaining rows of data. For each cell, the observation is recorded. An “N” shows no gelation while a “G” indicates gelation. A phase separated gel consisting of gel and free water is indicated by “P/S”. The actual measured pH of the solution is shown in parentheses. These observations were generally recorded after one week of observation and represent the state at that time. Most of the gels formed over several days, although some of the samples with the higher concentrations of polyamine crosslinker at high pH gelled almost immediately.

For purposes herein the wt % of the PHPA is listed followed by the weight average molecular weight, expressed as either million Daltons (MDa) or in grams per mol (g/mol), followed by the % hydrolysis of the PHPA expressed as a wt %. Accordingly, the heading: 2% PHPA, 12.5 MDa, 30% Hyd represents a composition comprising 2 wt % PHPA having a weight average molecular weight of 12.5 million Daltons, and a 30 wt % hydrolysis of acrylamide to acrylate. The weight average molecular weight may also be abbreviated “MW”, which indicates g/mol.

TABLE 1

| | 5% PHPA | 5% PHPA | 3% PHPA | 3% PHPA |
|---|---|---|---|---|
| | 5 MDa | 5 MDa | 5 MDa | 5 MDa |
| | 10% Hyd | 10% Hyd | 10% Hyd | 10% Hyd |
| pH | 5% TEPA | 5% PEHA | 5% TEPA | 5% PEHA |
| 1 | — | N (2.5) | — | — |
| 3 | N (3.1) | N (4.6) | N (3.1) | N (3.1) |
| 5.6 | N (6.0) | N (8.7) | N (6.0) | N (6.0) |
| 9 | G (12.0) | G (10.5) | G (12.0) | G (12.0) |
| 11 | G (12.8) | — | G (12.8) | G (12.8) |

As shown in Table 1, the PHPA was evaluated at concentrations of 3% and 5% by weight. Gels formed under basic conditions at ambient temperature.

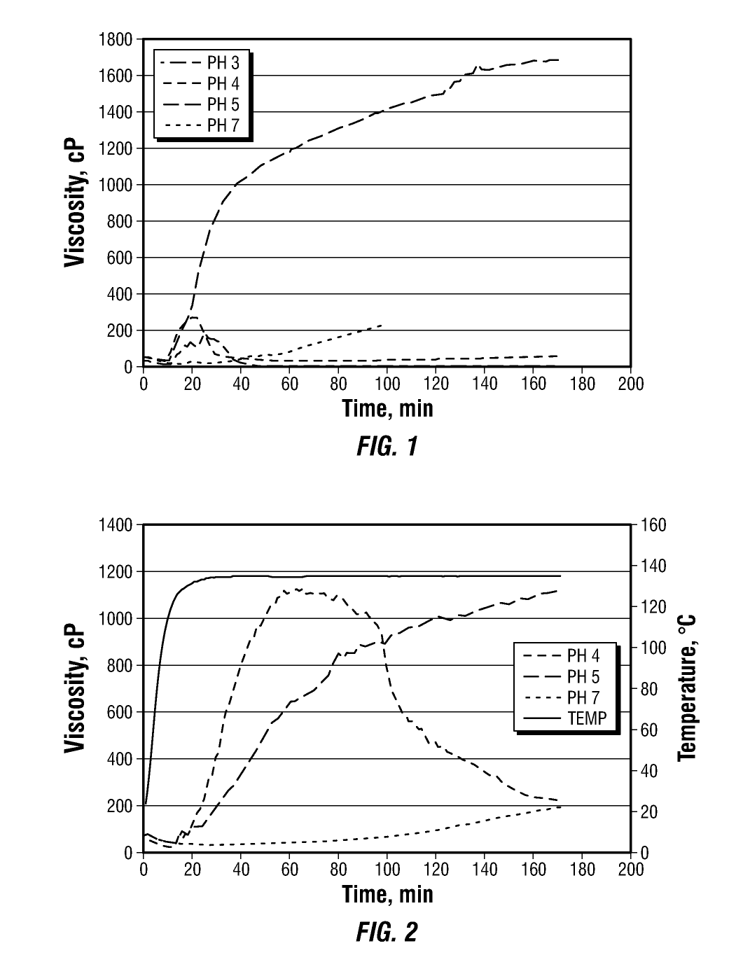

A series of gels were prepared according to Table 2 using 1 wt % PHPA combined with 0.1 wt % TEPA at the pH indicated in Table 2 and the high temperature stability (149° C.) was measured. The results are shown graphically in FIG. 1. As the data shows, a gel was formed at pH 5 and 7 which was stable at high temperature. The gels formed at lower pH were not as stable at 149° C. over time.

TABLE 2

| Sample | 1 | 2 | 3 | 4 |
|---|---|---|---|---|
| Wt % PHPA | 1 wt % | 1 wt % | 1 wt % | 1 wt % |
| Wt % TEPA | 0.1 wt % | 0.1 wt % | 0.1 wt % | 0.1 wt % |
| pH | 3 | 4 | 5 | 7 |

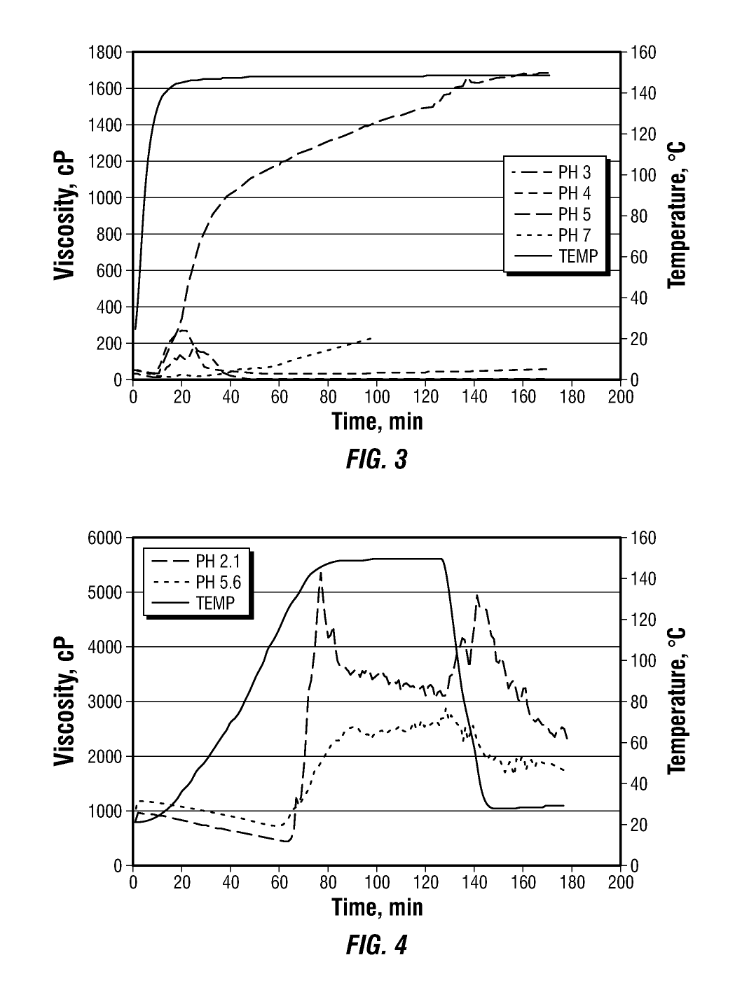

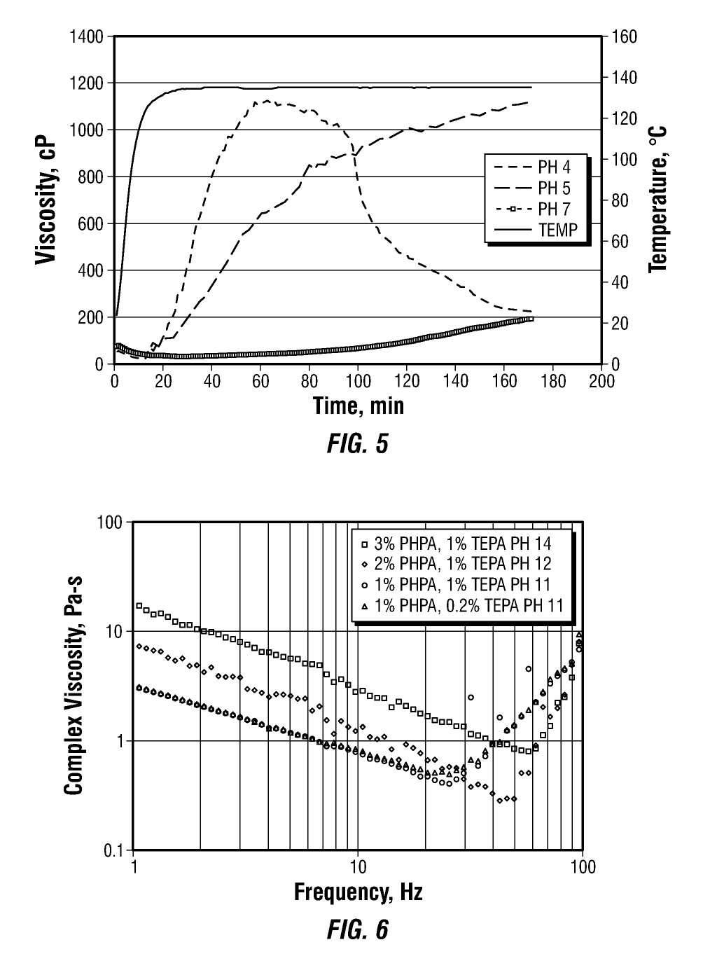

A series of gels were formed according to Table 3 at pH 4, 5, and 7 and the viscosity determined at 133° C. (275° F.). The data for Sample 5 is shown in FIG. 2; the data for Sample 6 is shown in FIG. 3; the data for Sample 7 is shown in FIG. 4; the data for Sample 8 is shown in FIG. 5.

TABLE 3

| Sample | 5 | | 6 | | 7 | | 8 | |
|---|---|---|---|---|---|---|---|---|
| | 1 wt % | PHPA | 1 wt % | PHPA | 3 wt % | PHPA | 1 wt % | PHPA |
| | 0.05 wt % | TEPA | 0.1 wt % | TEPA | 0.01 wt % | TEPA | 0.025 wt % | TEPA |
| | 2% | KCl Brine | | | | | 5% | KCl Brine |

A series of comparative examples were produced using 3 wt % PHPA crosslinked with polyethyleneimine polymer (PEI) and polyvinylamine polymer (PVAm) as indicated in

TABLE 4
As the results show, the polymeric polyamine crosslinkers formed
precipitates, thought to result from over crosslinked gels.

| Gel Composition | Ambient pH | pH 5 |
|---|---|---|
| 3 wt % PHPA | Precipitate | Precipitate |
| 1 wt % PEI | formed | formed |
| Wt Avg Mol. Wt. 2M g/mol | | |
| 3 wt % PHPA | Precipitate | Precipitate |
| 1 wt % PEI | formed | formed |
| Wt Avg Mol. Wt. 0.75M g/mol | | |
| 3 wt % PHPA | Precipitate | Precipitate |
| 1 wt % PVAm | formed | formed |
| Wt Avg Mol. Wt. 2M g/mol | | |
| 3 wt % PHPA | Clear fluid | Clear fluid |
| 1 wt % TEPA | | |

FIG. 6 shows the effect of PHPA concentration on gel viscosity for 1 wt % TEPA. Decreasing gel viscosity is found as PHPA concentration decreases.

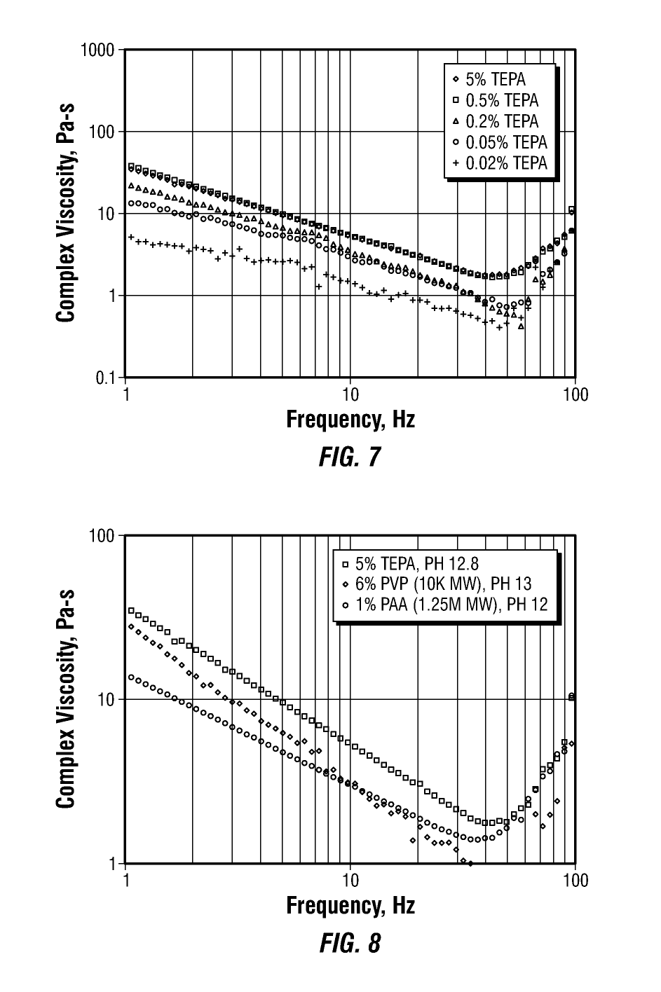

FIG. 7 shows the effect of TEPA concentration on gel viscosity at 3 wt % PHPA. Decreasing gel viscosity is found as TEPA concentration decreases.

FIG. 8 shows a comparison between a PHPA gel crosslinked with TEPA and a comparative PHPA gel crosslinked with PVP. As the data shows, TEPA forms a stronger gel than PVP.

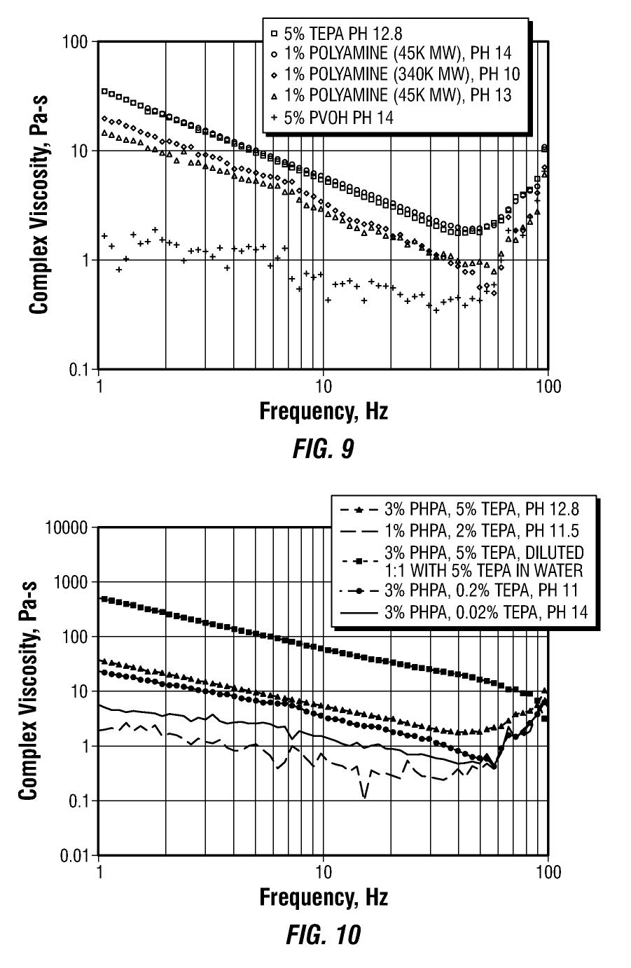

FIG. 9 shows that 5 wt % TEPA crosslinked PHPA gels have similar properties at pH 12.8 to that of comparative gels crosslinked with a 45K MW polyvinyl amine polymer at very high pH, i.e., pH=14. As the data shows, lowering of the pH of the comparative gels to 13 drastically reduces the properties of the polyvinyl amine crosslinked gel. A comparative gel in FIG. 9 crosslinked with polyvinyl alcohol is also shown to form a very weak gel.

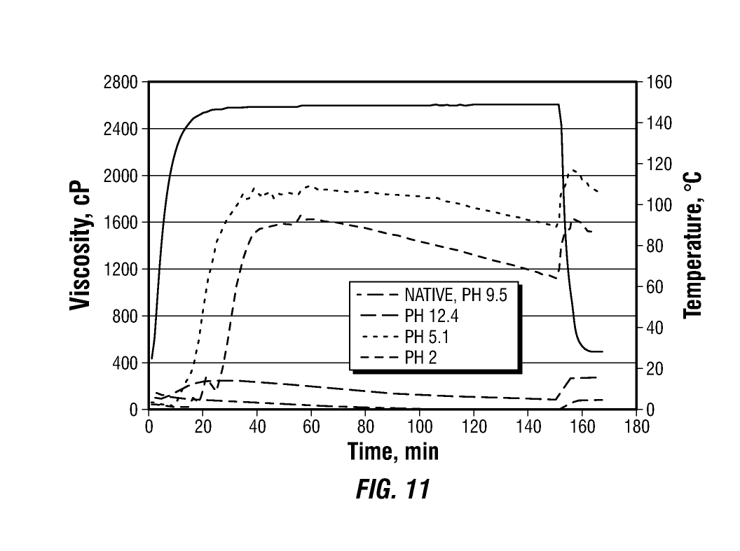

FIG. 10 shows that gels according to the instant disclosure form at very low amounts of TEPA. FIG. 11 shows that gels according to the instant disclosure form at very low amounts of PEHA.

PHPA Mixed with Another PHPA does not Gel

A comparative composition comprising the low molecular weight PHPA (0.5M g/mol, 5% hydrolysis) was combined with the 5M g/mol 10% hydrolysis PHPA to determine if any transamidation reaction would occur to form a gel among polyacrylamide molecules themselves. As expected, experiments showed no gel formed at pH 12.

### Dehydration of Gels and Reconstitution of Gels

A gel was produced according to the instant disclosure. The gel was freeze dried to produce a gel concentrate having less than 1 wt % water. The gel concentrate was then re-hydrated by mixing in water to produce a reconstituted gel having essentially the same properties as the gel prior to freeze drying.

The foregoing disclosure and description is illustrative and explanatory thereof and it can be readily appreciated by those skilled in the art that various changes in the size, shape and materials, as well as in the details of the illustrated construction or combinations of the elements described herein can be made without departing from the spirit of the disclosure.

While the invention has been illustrated and described in detail in the drawings and foregoing description, the same is to be considered as illustrative and not restrictive in character, it being understood that only some embodiments have been shown and described and that all changes and modifications that come within the spirit of the inventions are desired to be protected. It should be understood that while the use of words such as preferable, preferably, preferred, more preferred or exemplary utilized in the description above indicate that the feature so described may be more desirable or characteristic, nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

I claim:

1. A gel comprising, greater than or equal to about 0.5 wt % polyacrylamide crosslinked with a non-metallic crosslinker comprising a polyamine having a molecular weight of less than 500 g/mol.

2. The gel of claim 1, wherein the gel comprises greater than or equal to about 0.01 wt % of the non-metallic crosslinker.

3. The gel of claim 1, wherein the non-metallic crosslinker is selected from the group consisting of: tetraethylenepentamine, pentaethylenehexamine, 1,3-diaminopropane, diethylenetriamine, triethylenetriamine, tetraethylenepentamine, diethylene triamine, tetraethylmethylenediamine, triethylenetetraamine, putrescine, cadaverine, spermidine, spermine, 1,4,7,10-tetraazacyclododecane, polyethyleneimines, polypropyleneimines, polypyrrole, polyaniline, ethylenediamine, propylenediamine, butylenediamine, hexamethylenediamine, phenylenediamine, tolylenediamine, diethyltoluenediamine, dimethylthiotoluenediamine xylylenediamine, and a combination thereof.

4. The gel of claim 1, wherein the non-metallic cross linker is tetraethylenepentamine, pentaethylenehexamine, or a combination thereof.

5. The gel of claim 1, having a pH of less than or equal to about 3, or greater than or equal to about 9.

6. The gel of claim 1, having a complex viscosity of greater than or equal to about 100 Pa·s at less than or equal to about 0.01 Hz.

7. The gel of claim 1, wherein G′-G″ is greater than or equal to about 0.1 Pa·s wherein G′ and G″ are determined using an oscillatory shear rheometer at a frequency of 1 Hz and at 20° C.

8. A method to produce a gel comprising:
contacting a composition comprising greater than about 0.5 wt % polyacrylamide with a non-metallic crosslinker comprising a polyamine having a molecular weight of less than 500 g/mol, at a pH of greater than or equal to about 9, or less than or equal to about 3, at a temperature and for a period of time sufficient to produce the gel,
wherein the polyacrylamide concentration in the gel is greater than or equal to about 0.5 wt %, and wherein the concentration of the non-metallic crosslinker in the gel is greater than or equal to about 0.01 wt %, based on the total weight of the gel.

9. The method of claim 8, wherein the amount of the non-metallic crosslinker contacted with the polyacrylamide is sufficient to produce a gel having a concentration of the polyamine in the gel of greater than or equal to about 0.1 wt %, based on the total weight of the gel.

10. The method of claim 8, wherein the non-metallic crosslinker is selected from the group consisting of: tetraethylenepentamine, pentaethylenehexamine, 1,3-diaminopropane, diethylenetriamine, triethylenetriamine, tetraethylenepentamine, diethylene triamine, tetraethylmethylenediamine, triethylenetetraamine, putrescine, cadaverine, spermidine, spermine, 1,4,7,10-tetraazacyclododecane, polyethyleneimines, polypropyleneimines, polypyrrole, polyaniline, ethylenediamine, propylenediamine, butylenediamine, hexamethylenediamine, phenylenediamine, tolylenediamine, diethyltoluenediamine, dimethylthiotoluenediamine xylylenediamine, and a combination thereof.

11. The method of claim 8, wherein the non-metallic cross linker is tetraethylenepentamine, pentaethylenehexamine, or a combination thereof.

12. The method of claim 8, wherein the temperature is greater than or equal to about 50° C.

13. A method to produce a gel concentrate comprising:
contacting a composition comprising greater than about 0.5 wt % polyacrylamide at least partially dissolved in a solvent with a non-metallic crosslinker comprising a polyamine having a molecular weight of less than 500 g/mol, at a pH of greater than or equal to about 9, at a temperature and for a period of time sufficient to produce a gel,
wherein the polyacrylamide concentration in the gel is greater than or equal to about 0.5 wt %, and wherein the concentration of the non-metallic crosslinker in the gel is greater than or equal to about 0.01 wt %, based on the total weight of the gel; and
removing at least a portion of the solvent from the gel to produce the gel concentrate.

14. The method of claim 13, wherein the solvent comprises water and removing at least a portion of the solvent from the gel comprises freeze drying.

15. The method of claim 13, wherein the non-metallic crosslinker is selected from the group consisting of: tetraethylenepentamine, pentaethylenehexamine, 1,3-diaminopropane, diethylenetriamine, triethylenetriamine, tetraethylenepentamine, diethylene triamine, tetraethylmethylenediamine, triethylenetetraamine, putrescine, cadaverine, spermidine, spermine, 1,4,7,10-tetraazacyclododecane, polyethyleneimines, polypropyleneimines, polypyrrole, polyaniline, ethylenediamine, propylenediamine, butylenediamine, hexamethylenediamine, phenylenediamine, tolylenediamine, diethyltoluenediamine, dimethylthiotoluenediamine xylylenediamine, and a combination thereof.

16. A method to produce a reconstituted gel comprising:
contacting a gel concentrate with a solvent at a pH, at a temperature and for a period of time sufficient to produce a reconstituted gel from the gel concentrate, wherein the gel concentrate comprises polyacrylamide crosslinked with a non-metallic crosslinker, and wherein the non-metallic crosslinker comprises a polyamine having a molecular weight of less than 500 g/mol.

17. The method of claim 16, wherein the non-metallic crosslinker is selected from the group consisting of: tetraethylenepentamine, pentaethylenehexamine, 1,3-diaminopropane, diethylenetriamine, triethylenetriamine, tetraethylenepentamine, diethylene triamine, tetraethylmethylenediamine, triethylenetetraamine, putrescine, cadaverine, spermidine, spermine, 1,4,7,10-tetraazacyclododecane, polyethyleneimines, polypropyleneimines, polypyrrole, polyaniline, ethylenediamine, propylenediamine, butylenediamine, hexamethylenediamine, phenylenediamine, tolylenediamine, diethyltoluenediamine, dimethylthiotoluenediamine xylylenediamine, and a combination thereof.

18. A method of treating a wellbore comprising:
injecting a composition comprising a gel into a wellbore, wherein the gel comprises greater than or equal to about 0.5 wt % polyacrylamide crosslinked with a non-metallic crosslinker comprising a polyamine having a molecular weight of less than 500 g/mol.

19. A method of treating a wellbore comprising:
injecting a composition comprising greater than about 0.5 wt % polyacrylamide into a wellbore;
injecting a composition comprising a non-metallic crosslinker comprising a polyamine having a molecular weight of less than 500 g/mol into the wellbore, and
injecting a pH adjusting fluid into the wellbore in an amount sufficient to produce a downhole solution pH of greater than or equal to about 9 or less than or equal to about 3, to produce a gel in-situ, the in-situ gel comprising greater than or equal to about 0.5 wt % polyacrylamide crosslinked with greater than or equal to about 0.01 wt % of the non-metallic crosslinker,
wherein the composition comprising greater than about 0.5 wt % polyacrylamide, the composition comprising a non-metallic crosslinker, and the pH adjustment fluid are injected into the wellbore separately, simultaneously, or any combination thereof.

20. The method of claim 19, wherein the non-metallic crosslinker is selected from the group consisting of: tetraethylenepentamine, pentaethylenehexamine, 1,3-diaminopropane, diethylenetriamine, triethylenetriamine, tetraethylenepentamine, diethylene triamine, tetraethylmethylenediamine, triethylenetetraamine, putrescine, cadaverine, spermidine, spermine, 1,4,7,10-tetraazacyclododecane, polyethyleneimines, polypropyleneimines, polypyrrole, polyaniline, ethylenediamine, propylenediamine, butylenediamine, hexamethylenediamine, phenylenediamine, tolylenediamine, diethyltoluenediamine, dimethylthiotoluenediamine xylylenediamine, and a combination thereof.

21. A method of treating a wellbore comprising: injecting a composition comprising a gel concentrate into a wellbore, wherein the gel concentrate comprises polyacrylamide crosslinked with a non-metallic crosslinker, wherein the non-metallic crosslinker comprises a polyamine having a molecular weight of less than 500 g/mol.

22. The method of claim 21, wherein the non-metallic crosslinker is selected from the group consisting of: tetraethylenepentamine, pentaethylenehexamine, 1,3-diaminopropane, diethylenetriamine, triethylenetriamine, tetraethylenepentamine, diethylene triamine, tetraethylmethylenediamine, triethylenetetraamine, putrescine, cadaverine, spermidine, spermine, 1,4,7,10-tetraazacyclododecane, polyethyleneimines, polypropyleneimines, polypyrrole, polyaniline, ethylenediamine, propylenediamine, butylenediamine, hexamethylenediamine, phenylenediamine, tolylenediamine, diethyltoluenediamine, dimethylthiotoluenediamine xylylenediamine, and a combination thereof.

23. A well treatment fluid comprising the gel of claim 1.
